(19) United States
(12) Patent Application Publication
(10) Pub. No.: US 2005/0233780 A1
(43) Pub. Date: Oct. 20, 2005

(54) System and method for power management in a mobile communications device

(75) Inventors: Pulkkinen Jani, Espoo (FI); Torvinen Marko, Espoo (FI); Kurhila Mikko, Helsinki (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/827,986

(22) Filed: Apr. 20, 2004

(51) Int. Cl. H04B 1/38

(52) U.S. Cl. 455/574

(57) ABSTRACT

A system, method, device, and computer program that provide a power management profile for a mobile communication device. The system includes a base station and a mobile communication device in communication with the base station. After the device, receives a power conservation initiation signal, the device initiates a power conservation profile in which one or more of the following actions may be taken: 1) reduce the frequency that the device registers with the base station; 2) switch the device to a messaging only mode; 3) disconnect the device from the base station after receiving messages; and 4) switch the device into “sleep” mode after disconnecting the device from the base station. The messaging only mode may comprise sending and receiving communications through SMS, MMS, IM, or e-mail.

### FIELD OF THE INVENTION

This invention relates generally to mobile communication devices and, in particular, to the power management of mobile communication devices.

### BACKGROUND OF THE INVENTION

Wireless communication is becoming more widespread as a continually increasing number of users acquire and place into operation ever-greater numbers of mobile communication devices. Along with this increase in the number of mobile devices there is an increase in the amount of time the mobile devices are in use. This places an ever increasing demand on the amount of time mobile devices are able to provide functionality before the power source for the device requires re-charging.

In addition to processing voice calls from other mobile communication devices and from land base phones, mobile communication devices now also communicate with other devices such as personal computers and Personal Data Assistants (PDA's). In addition to voice calls, mobile communication devices now also communicate messages through e-mail in non-real time, through Instant Messaging (IM) in real time, and through text messaging services which are a hybrid of e-mail and IM. Text messaging services provided for mobile communication devices include the Short Messaging Service (SMS) and the Multimedia Messaging Service (MMS). SMS is a mechanism for delivering short messages over mobile networks. SMS is a store and forward method of transmitting messages to and from mobiles devices and has become an essentially universal mobile data service. SMS can also be used for e-mail messages and IM transmissions. MMS is rapidly becoming another industry standard for organizing communications between devices in a non-real time way. MMS conveys messages to and from mobile communication devices in a store-and-forward manner much like the SMS text messages, but MMS allows a combination of text, sounds, images, and video. MMS also supports pictures and interactive video.

Although both e-mail and SMS are “store and forward” systems that utilize a gateway to pass messages from senders to recipients, the most obvious difference between the two are the length and complexity of the messages. SMS messages are limited to between 80 to 500 characters depending on the service provider. A typical SMS message consists of about 120 characters. Messages generated by SMS are immediately delivered directly to the device. While e-mail lets you attach files, imbed images, and make use of HTML, SMS messages generally are limited to text and numeral display. MMS, on the other hand, provides support for not just text, but also sounds, images, and video for more complex message transmission.

E-mail has become a necessary tool and is by far the most popular messaging service currently in use in North America. There are millions of business e-mail accounts today with the average employee receiving about thirty e-mails per day. In many companies, e-mail is the preferred method of communication—even between people that sit relatively close to each other. Mobile workers who are cut off from e-mail risk missing valuable business opportunities when unable to check their inbox. The user of an SMS or MMS enabled mobile communication device can choose to have an email address assigned to the device, allowing friends and colleagues to send e-mail messages directly to the device using either native e-mail support at the device or SMS or MMS capability for formatting the messages. Thus, it is possible to send e-mail messages from a mobile phone to any e-mail address via SMS. Many communication systems offer e-mail service over SMS and some systems now offer e-mail service over MMS. Each user is assigned an e-mail address at signup and any message delivered to that email is converted to short messages or multimedia messages and delivered to the mobile communication device.

On the other hand, Instant Messaging Service (IMS), made popular by AOL Instant Messenger, provides a user access to a virtually real-time text conversation (or chat) with people who are simultaneously connected to the Internet. SMS messages are immediate, but not simultaneous. SMS messages are sent to and processed by a Short Message Service Center, which then delivers the message to the intended recipient's mobile communication device. Mobile communication devices now support IM based on SMS technology giving people the ability to join public chat rooms, or create “friends lists” similar to IM software deployed on the Internet. Using IM, a user can monitor other people's status or notify a user when another person comes online. Mobile users can have access to their buddy lists and can see who is online just as with PC-based IM. When offline, mobile IM users can be invited to IM via an SMS text message sent by a buddy from an IM application. Buddy lists can show if somebody is online, on a phone, or on a PC.

When a mobile communication device is turned on, the device listens on the control channel for a System Identification code (SID) which is a unique five digit number assigned to each communications carrier. The control channel is a special frequency that the device uses to talk with a base station for call set-up and channel changing. When the device receives a control channel and receives a SID over the control channel from the base station, the device compares the received SID to the SID programmed into the device. If the SIDs match, the device knows that it is communicating with a base station that is part of the home system for the device. The device also transmits a registration request to the base station that is relayed to the Mobile Telephone Switching Office (MTSO). The MTSO is a central office that handles all of the mobile communication device connections to the normal land-based phone system and controls all of the base stations in a region. The network keeps track of the mobile device's location in a database so that the MTSO knows in which base station cell the device is located when a call is received. As the mobile device moves between base station cells, the device detects changes in the control channel's strength and re-registers itself with a new cell when it changes channels. The registration process is performed periodically and consumes significant device power resources.

A mobile phone runs a self diagnostic when it's powered up. Once completed it acts like a scanning radio. Searching through its list of forward control channels, it picks the one with the strongest signal, which is usually provided by the nearest base station. The mobile communication device re-scans every seven seconds or when signal strength drops below a pre-determined threshold. Registration is an ongoing process. Moving from one service area to another causes registration to begin again. Additionally, registration is performed periodically as an automatic activity of the system to update the status of the mobile communication device. The base station may also initiate registration on its own by sending a signal to the mobile communication device forcing the device to transmit and to identify itself. Registration also takes place just before a call is placed.

Currently, the most effective way to conserve power, and thereby extend the amount of time the device can be used, is simply to turn the device off. The problem with this method is that it also reduces the effectiveness of the mobile device. When the device is turned off, no messages or calls can be received at all. Thus, no device functionality is maintained when the device is turned off. Additionally, turning the device on requires an additional power draw on the battery above the usual operational power consumption of the device. Thus, turning the device on, and then off, and then on again, serves to further reduce the power reserves of the device.

Consequently, a need exists for power conservation of mobile communication devices that reduces the power consumption of the device while retaining at least some of the device functionality. Thus, there is a need for an improved method, device, computer program, and system that provides functionality while managing the power usage of the device. Further, there is a need to indicate to callers of the device that the device is in a power conservation mode of operation.

### SUMMARY OF THE INVENTION

The present invention is directed to a method, computer program product, system, and device that provide a power management profile for a mobile communication device.

Briefly, one exemplary embodiment relates to a method for managing the power usage of a mobile communication device. The method comprises registering the device with a base station, receiving a power conservation initiation signal at the device, reducing the frequency of the device registering with the base station at the device in response to receiving the power conservation initiation signal and switching the device to a messaging only mode at the device in response to receiving the power conservation initiation signal. In one embodiment, the power conservation initiation signal is generated by a user of the device. In an alternative embodiment, the power conservation initiation signal is generated by the device in response to the power level of the device being lower than a predetermined threshold. The messaging only mode can be any one of a variety of messaging types such as SMS, MMS, IM, and/or e-mail.

The method further comprises receiving a call at a network server, the call sent to the device from a caller, and sending the caller a message from the network server, the message indicating the device is in messaging only mode. The message can be an SMS, MMS, IM, e-mail, voicemail, or any other message type. The method further comprises selecting a contact preference at the device, sending the contact preference from the device to the base station, sending the contact preference from the base station to a network server, and storing the contact preference at the network server. The contact preference can be, among other message types, an SMS, MMS, IM, and/or e-mail message. The message sent to the caller may further comprise the contact preference for the device so that the caller may contact the device using this messaging mode.

Another exemplary embodiment relates to a computer program product that manages the power usage of the mobile communication device. The computer program product comprises computer code configured to reduce the frequency of registering the device with a base station and switch the device to a messaging only mode in response to a power conservation initiation signal. The computer code may further be configured to generate the power conservation initiation signal when the power level of the device is lower than a predetermined threshold.

Still another exemplary embodiment relates to a system that manages the power usage of the mobile communication device. The system comprises a base station communicatively connected to a network and capable of communicating messages, and the device that is communicatively connected to the base station. The device receives a power conservation initiation signal and reduces the frequency of registering the device with the base station and switches to a messaging only mode after receiving the power conservation initiation signal. The system may further comprise a network server communicatively connected to the base station, wherein the network server receives a call sent to the device from a caller; and sends the caller a message indicating that the device is in messaging only mode. The device may further send a contact preference to the base station. The base station sends the contact preference to the network server. The network server stores the contact preference. The message sent to the caller from the network server may further comprise the stored contact preference.

Another exemplary embodiment relates to a device that is configured for operation in a communication network. The device comprises a communication interface and a processor coupled to the communication interface. The communication interface registers with a base station of the communication network and receives and transmits messages from the base station. The processor reduces the frequency that the communication interface registers with the base station and switches the device to a messaging only mode after the processor receives a power conservation initiation signal. The communication interface may further disconnect the device from the base station after receiving messages. The processor may further switch the device to a sleep mode after the communication interface disconnects from the base station. The communication interface may further send a contact preference to the base station. The processor may further generate the power conservation initiation signal in response to the power level of the device being lower than a predetermined threshold.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a diagrammatic representation of a communication system in accordance with an exemplary embodiment.

FIG. 2 is a diagrammatic representation of a mobile communication device in the system of FIG. 1 in accordance with an exemplary embodiment.

FIG. 3 is a flow diagram depicting operations in a communication system with power level monitoring in accordance with an exemplary embodiment.

FIG. 4 is a flow diagram depicting operations in a communication system providing a power conservation mode of operation in accordance with an exemplary embodiment.

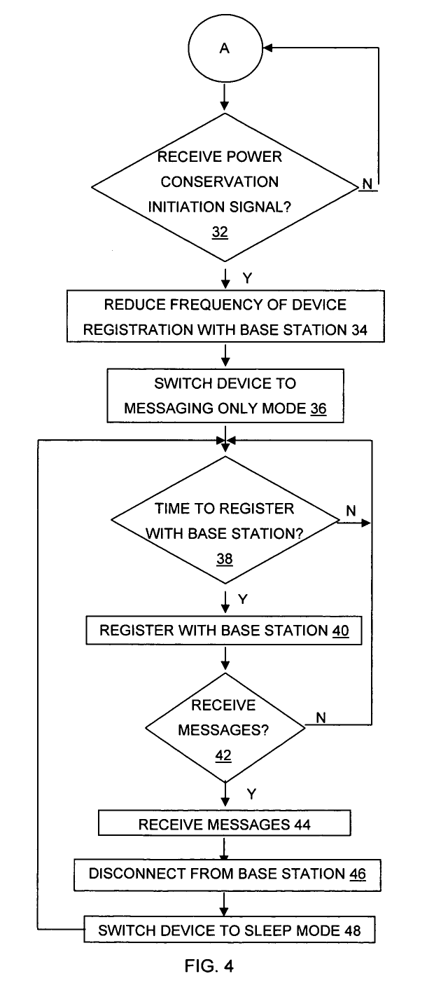

FIG. 5 is a flow diagram depicting operations in a communication system at a network server in accordance with an exemplary embodiment.

FIG. 6 is a diagrammatic representation of the system of FIG. 1 with an exemplary embodiment of contact preference selection and storage.

### DETAILED DESCRIPTION OF EXEMPLARY EMBODIMENTS

Currently, mobile communication devices use various profiles for different environmental conditions, e.g., silent or vibrate profiles that turn off the ringer of the device and outdoor profiles that can be enabled in noisy outdoor environments. What has not been done is using a profile for power management under circumstances where it is important to conserve power for the device. An example circumstance where power conservation might be important is during a long hiking trip or camping trip where it is important to maintain device functionality, in case of an emergency, while conserving power resources because the device can not be conveniently re-charged. Another example occurs when a business person is traveling by car or train and requires device functionality so that urgent messages can be received while conserving power resources because the device can not be conveniently re-charged. Features that save power have been available (such as deactivating backlighting), but have never been implemented as part of a power management profile for specific circumstances. Incorporation of a power management profile in accordance with an exemplary embodiment conserves power while continuing to provide some of the device functionality. The activation of such a power management profile modifies mobile communication device functionality so as to realize power savings.

The term “mobile communication device” should be understood to include cellular telephones; PDAs with telephonic or wireless communication capabilities such as those manufactured by PALM, Inc.; Instant Messaging Devices, such as those manufactured by Blackberry, Inc.; notebook computers with telephonic or wireless communication capabilities; and other mobile devices that can communicate using various transmission technologies (including CDMA, GSM, TDMA, and others) or media (radio, infrared, laser, and the like).

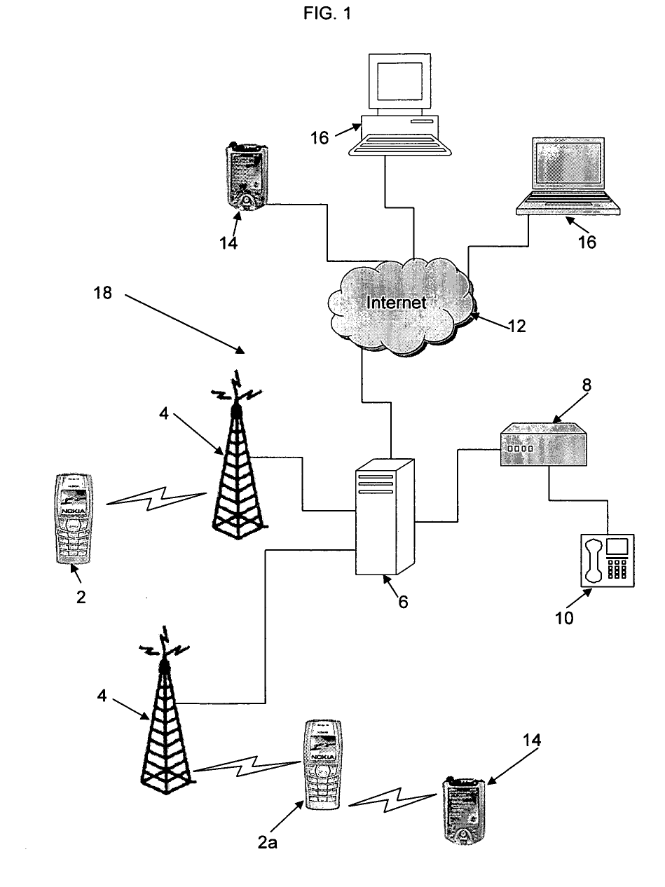

FIG. 1 illustrates a communication system 18 having a mobile communication device 2, a base station 4, and a network server 6. The network server 6 allows communication between the device 2 and other devices 2a and device types. These other device types include PDAs 14, personal computers 16, and traditional phones 10. The network server 6 may connect traditional phones 10 with the device 2 through a Public Switched Telephone Network (PSTN) 8. The network server 6 may connect PDAs and personal computers with the device 2 through the Internet 12. The device 2 can be any of a variety of different communication devices, such as a PDA, a phone, a computer, or a computing device integrated into another apparatus. The base station 4 can be a station located proximate the device 2 that provides communication to and from the device 2. Communications to and from the device 2 can be communicated to and from the network server 6.

The base station 4 receives both calls and messages from the network server 6, which receives them from other simple and complex devices as shown in FIG. 1. Text messaging services provided for mobile communication devices include the SMS and the MMS. Mobile communication devices may also send and receive messages in the form of e-mail or IM. E-mail and/or IM may themselves be based on the SMS and the MMS.

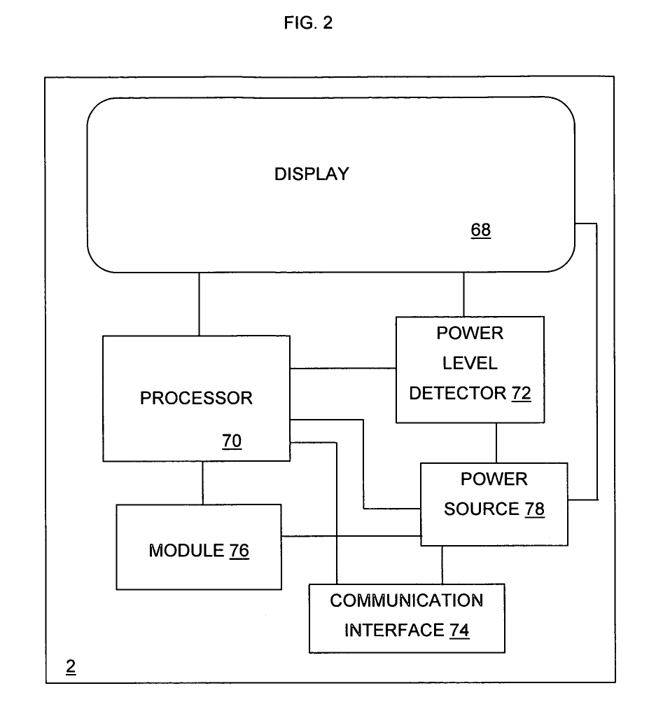

In an exemplary embodiment, the device 2, as shown in FIG. 2, has a display 68, a processor 70, a power level detector 72, a communication interface 74, a module 76, and a power source 78. The display 68 presents messages for display and editing in addition to other information including an indication of the power source 78 charge level. The display 68 can be a thin film transistor (TFT) display, a light emitting diode (LED) display, or any of a variety of different displays. The module 76 can be a computer chip or an arrangement of programmed instructions directing the handling of messages, such as complex multimedia messages utilizing the MMS. The processor 70 executes instructions from the module 76 and instructions contained within the processor 70. The communication interface 74 provides an interface for receiving and transmitting calls and messages from the base station 4. The power level detector 72 determines the remaining charge on the power source 78 for the device 2.

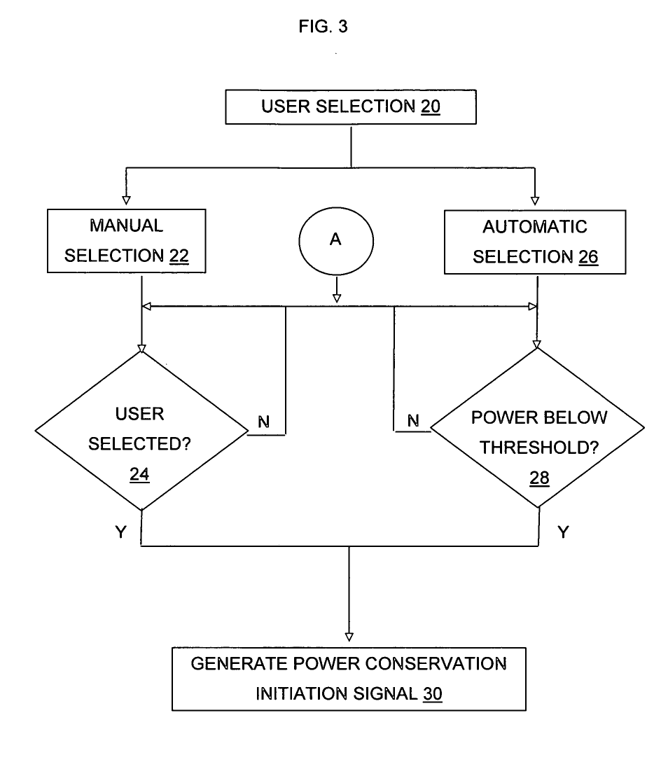

The power conservation initiation signal may be any signal suitable to initiate power saving measures. Typically the power conservation initiation signal is an electronic signal that can be generated, transmitted, received, and understood by electronics typically employed in mobile communication devices 2. As shown in the exemplary embodiment of FIG. 3, the power conservation initiation signal may be generated using two different operational flows. In an operation 20, the user of the device selects the operational flow to be employed for generating the power conservation initiation signal for that device. The operational flow for switching the mobile communication device 2 into the power conservation profile or mode of operation may be either a manual selection, as shown at operation 22, or an automatic selection, as shown at operation 26. The selection of manual or automatic may be accomplished by selecting a menu option, a button, or executing a keystroke combination. Where operation 22 was selected for the device, the power conservation initiation signal is generated by the user who selectively engages the power conservation profile in an operation 24. Until the user selects the power conservation mode, the processor waits until the user decides to activate the power conservation profile. Typically, this is done through the user interface of the mobile communication device 2. It may be selectable through a menu, a button, or execution of a keystroke combination. When the user selects the power conservation profile, the power conservation initiation signal is generated at an operation 30.

Alternatively, the power conservation initiation signal is generated in response to a decrease in the power level of the mobile communication device below a predetermined threshold as shown in operation 28. Most mobile communication devices have some sort of power level meter or readout. When the power level as indicated by this meter or readout drops below the predetermined threshold, a power conservation initiation signal is generated at operation 30. The predetermined threshold level may be factory set or user defined depending on application or use. Other embodiments will be apparent to one skilled in the art given the benefit of this disclosure. When the automatic selection of operation 26 is selected by the user, the processor 70 begins monitoring the power level detector reading sent from the power level detector 72 to the processor 70. When the power level drops below the predetermined threshold, the power conservation initiation signal is generated at an operation 30.

After the device 2, receives the power conservation initiation signal at operation 32, the device 2 initiates a power conservation profile in which one or more of the following actions may be taken: 1) reduce the frequency that the device 2 registers with the base station 4, as shown at operation 34; 2) switch the device to a messaging only mode, as shown at operation 36; 3) disconnect the device 2 from the base station 4 as shown at operation 46 after receiving messages at operation 44; and 4) switch the device 2 into “sleep” mode after disconnecting the device 2 from the base station 4, as shown at operation 48. In an exemplary embodiment, all of these power conserving actions are performed until the user disables the power conservation profile. Disabling the power conservation profile may be accomplished by selecting a menu option, a button, or executing a keystroke combination.

The device 2 periodically registers with the base station 4 because the particular base station 4 may be changing in location as the device 2 moves geographically. Reducing the frequency of these registrations with the base station 4 conserves the power resources of the device 2 by increasing the amount of time between registrations so that there are fewer registrations during the same time interval. For example, instead of registering with the base station 4 once every minute, the device 2 registers with the base station 4 only once every ten minutes. Thus, the frequency of registrations has been decreased by a factor of ten. Operation 38 performs the time test for registration. If it is time to register with the base station 4, the device 2 registers with the base station 4 as shown at operation 40. The device 2 then receives any messages sent to the device 2 at operation 44. The device 2 then conserves power resources by disconnecting from the base station 4 and switching to a “sleep” mode until it is time to register again with the base station 4. The “sleep” mode is a mode of operation that consumes very little power by effectively disabling the device without actually powering off the device 2.

Switching the device 2 to messaging only mode, disables the receipt of calls at the device 2 until the user disables the power conservation profile. Calls require greater power utilization based on the required synchronization of the device 2 with the base station 4 than do messages transmitted using short messages like “See you tonight at 6:30.” Calling someone invariably requires more time and hence greater power utilization. Thus, messaging only mode allows the user to communicate through the device 2 while using less of the device power resource. When necessary, the user can be reached by sending a SMS message, for example, “Emergency. Call the office ASAP.” Similarly to receiving calls, short messages can be sent using fewer power resources than a voice call.

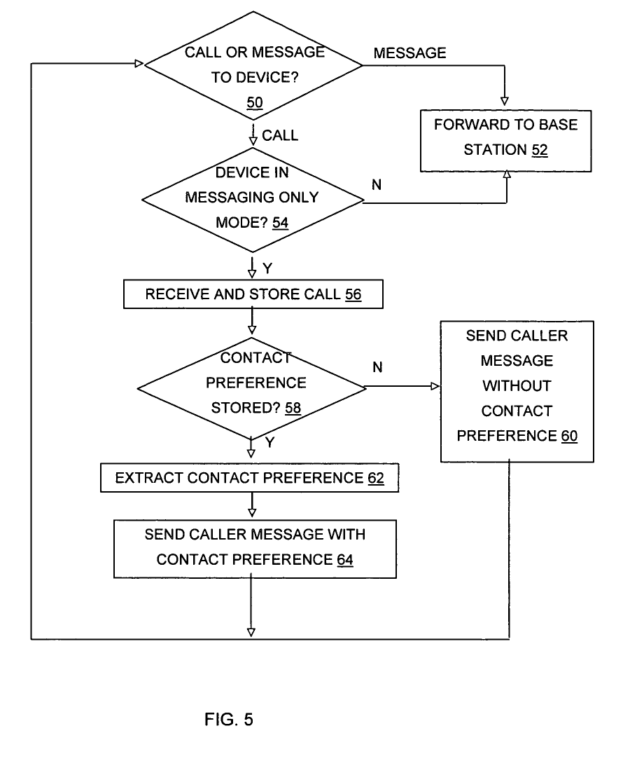

FIG. 5 depicts part of the operational flow at the network device 6, in an exemplary embodiment. The network device 6 receives a communication in the form of either a voice call or a message that is directed to the device 2. The processing at the network device 6 depends on whether the communication is a message or a call as shown at operation 50. If the communication is a message, the message is forwarded to the base station 4 for transmission to the device 2 at operation 52. If the communication is a call, the network server 6 determines if the device is in messaging only mode as shown at operation 54. If the device 2 is not in messaging only mode, the call is forwarded to the base station 4 for transmission to the device 2 at operation 52. If the device 2 is in messaging only mode, the network server may receive and store the call in a voicemail message as shown at operation 56. The network server 6 may additionally forward a message to the device 2 indicating that a voicemail has been recorded. The message typically will use the SMS though other message types may be used including voicemail. At operation 58, the network server 6 determines if a preferred contact message type was previously selected by the user of the device 2. If no contact preference was selected, the network server 6 creates and sends the caller of the device 2 a message in operation 60 indicating that the device 2 is in messaging only mode. If a contact preference was selected by the user of the device, the contact preference is extrated in operation 62 and the network server 6 creates and sends the caller a message that indicates that the device 2 is in messaging only mode and that the user of the device prefers to be contacted using a specific messaging mode in operation 64. The messaging mode may comprise SMS, MMS, IM, or e-mail. The contact preference may comprise any of SMS, MMS, IM, or e-mail. The message created at the network server 6 may use any of SMS, MMS, IM, e-mail, or voicemail as a message type. In an exemplary embodiment, the message type sent from the network server 6 to the caller is of the SMS message type. The message, for example, may comprise “Contact person A through SMS message. Person A is conserving power and is in messaging only mode.”

A person can selectively answer a message or deactivate the power conservation profile and place a call as required by the circumstances. The user may be notified that a new voice or SMS message is waiting. Thus, in this mode of operation the user can make calls and use applications, but call attempts initiated by other people do not reach the user's mobile communication device.

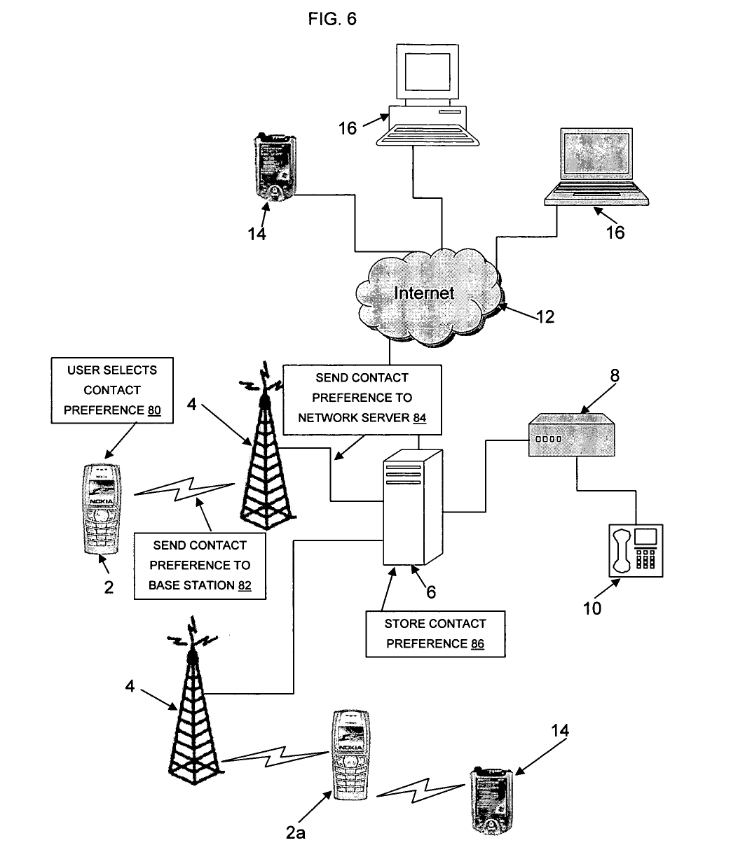

FIG. 6 depicts the operational flow for defining a contact preference. At operation 80, the contact preference is selected by the user of the device 2 using a menu option, a button, or a keystroke combination using the device interface. The contact preference is then sent to the base station 4 in operation 82 and base station 4 sends the contact preference to the network server 6 in operation 84. The network server 6 stores the contact preference in an accessible location in operation 86. For example, the network server 6 may store the contact preference in a database, a plain text file, an XML file, etc. in a memory located at the network server 6. Alternatively, the network server 6 may store the contact preference on, for example, another computer system connected through a network to the network server 6.

In an alternative embodiment, a computer program product is provided and executed by the processor 70. The computer program product handles messaging such as multimedia messaging through the MMS. The computer program product comprises computer code configured to reduce the frequency of registering the device with a base station in response to a power conservation initiation signal. The computer code may further be configured to switch the device to a messaging only mode in response to the power conservation initiation signal. Textual type messaging through e-mail, SMS, MMS, or IM requires less power to receive and to process at a mobile communication device while still providing continuous communication capability with other devices and device types. As a result, incoming calls are disabled in the messaging only mode due to the resulting large energy consumption. Thus, messaging only mode is a special messaging profile selected when it is crucial that the device user be reachable but also important to conserve the power resource of the device. The computer code may further be configured to generate the power conservation initiation signal when the power level of the device drops below a predetermined threshold.

This detailed description outlines exemplary embodiments of a method, device, computer program, and system for conserving power resources for a mobile communication device 2. In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different message types and message types in combination and different hardware and software for performing the same operations. The invention is not limited to a particular embodiment, but extends to various modifications, combinations, and permutations that nevertheless fall within the scope and spirit of the appended claims.

1. A method for managing the power usage of a mobile communication device, the method comprising:
registering the device with a base station;
receiving a power conservation initiation signal at the device; and
initiating a power conservation profile in response to receiving the power conservation initiation signal wherein initiating a power conservation profile comprises:
reducing the frequency of the device registering with the base station at the device in response to receiving the power conservation initiation signal; and
switching the device to a messaging only mode, at the device, in response to receiving the power conservation initiation signal.

2. The method of claim 1, wherein the messaging only mode is a messaging type selected from the group consisting of short messaging service, multimedia messaging service, instant messaging, and e-mail.

3. The method of claim 1, wherein initiating a power conservation profile comprises:
receiving messages at the device sent from the base station;
disconnecting the device from the base station after receiving the messages; and
switching the device to sleep mode at the device after disconnecting the device from the base station.

4. The method of claim 1, wherein the power conservation initiation signal is generated by a user of the device.

5. The method of claim 1, wherein the power conservation initiation signal is generated in response to the power level of the device being lower than a predetermined threshold.

6. The method of claim 1, further comprising:
receiving a call at a network server, the call sent to the device from a caller; and
sending the caller a message from the network server, the message indicating the device is in messaging only mode.

7. The method of claim 6, wherein messaging only mode is a messaging type selected from the group consisting of short messaging service, multimedia messaging service, instant messaging, and e-mail.

8. The method of claim 6, wherein the message is of a message type selected from the group consisting of short messaging service, multimedia messaging service, instant messaging, e-mail, and voicemail.

9. The method of claim 6, further comprising:
selecting a contact preference at the device;
sending the contact preference from the device to the base station;
sending the contact preference from the base station to the network server; and
storing the contact preference at the network server.

10. The method of claim 9, wherein the message further comprises the contact preference for the device.

11. The method of claim 10, wherein the contact preference is a messaging type selected from the group consisting of short messaging service, multimedia messaging service, instant messaging, and e-mail.

12. A computer program product for managing the power usage of a mobile communication device comprising:
computer code configured to:
initiate a power conservation profile in response to receiving a power conservation initiation signal wherein the power conservation profile initiation comprises:
reducing the frequency of registering the device with a base station in response to the power conservation initiation signal; and
switching the device to a messaging only mode in response to the power conservation initiation signal.

13. The computer program product of claim 12, wherein the messaging only mode is a messaging type selected from the group consisting of short messaging service, multimedia messaging service, instant messaging, and e-mail.

14. The computer program product of claim 12, wherein the power conservation profile initiation comprises:
registering the device with the base station;
receiving messages sent from the base station; and
disconnecting the device from the base station after receiving the messages.

15. The computer program product of claim 14, wherein the power conservation profile initiation further comprises switching the device to sleep mode after disconnecting the device from the base station.

16. The computer program product of claim 12, wherein the computer code is further configured to send a contact preference from the device to a network server.

17. The computer program product of claim 16, wherein the contact preference is a messaging type selected from the group consisting of short messaging service, multimedia messaging service, instant messaging, and e-mail.

18. The computer program product of claim 12, wherein the computer code is further configured to generate the power conservation initiation signal when the power level of the device is lower than a predetermined threshold.

19. A system for managing the power usage of a mobile communication device, the system comprising:
a base station communicatively connected to a network and capable of communicating messages to and from the device; and
the device communicatively connected to the base station wherein the device receives a power conservation initiation signal and initiates a power conservation profile in response to receiving a power conservation initiation signal, wherein the power conservation profile initiation comprises:
reducing the frequency of registering the device with the base station after receiving the power conservation initiation signal; and
switching the device to a messaging only mode after receiving the power conservation initiation signal.

20. The system of claim 19, wherein the messaging only mode is a messaging type selected from the group consisting of short messaging service, multimedia messaging service, instant messaging, and e-mail.

21. The system of claim 19, wherein the power conservation profile initiation comprises:
receiving a message from the base station; and
disconnecting from the base station after receiving the message.

22. The system of claim 21, wherein the power conservation profile initiation further comprises switching the device to sleep mode after disconnecting from the base station.

23. The system of claim 19, further comprising a network server communicatively connected to the base station, wherein the network server:
receives a call sent to the device from a caller; and
sends the caller a message indicating the device is in messaging only mode.

24. The system of claim 23, wherein the messaging only mode is a messaging type selected from the group consisting of short messaging service, multimedia messaging service, instant messaging, and e-mail.

25. The system of claim 23, wherein the message sent to the caller is of a message type selected from the group consisting of short messaging service, multimedia messaging service, instant messaging, e-mail, and voicemail.

26. The system of claim 23, further wherein:
the device sends a contact preference to the base station;
the base station sends the contact preference to the network server; and
the network server stores the contact preference.

27. The system of claim 26, wherein the message sent to the caller further comprises the contact preference.

28. The system of claim 27, wherein the contact preference is a messaging type selected from the group consisting of short messaging service, multimedia messaging service, instant messaging, and e-mail.

29. The system of claim 19, wherein the power conservation initiation signal is generated by a user of the device.

30. The system of claim 19, wherein the device further generates the power conservation initiation signal in response to the power level of the device being lower than a predetermined threshold.

31. A device configured for operation in a communication network, the device comprising:
a communication interface that registers with a base station of the communication network and that receives and transmits messages from the base station; and
a processor coupled to the communication interface wherein the processor receives a power conservation initiation signal and initiates a power conservation profile in response to receiving a power conservation initiation signal wherein the power conservation profile initiation comprises:
reducing the frequency that the communication interface registers with the base station after the processor receives a power conservation initiation signal; and
switching to a messaging only mode after receiving the power conservation initiation signal.

32. The device of claim 31, wherein the messaging only mode is a messaging type selected from the group consisting of short messaging service, multimedia messaging service, instant messaging, and e-mail.

33. The device of claim 31, wherein the communication interface further disconnects from the base station after receiving the messages.

34. The device of claim 33, wherein the power conservation profile initiation comprises switching the device to sleep mode after the communication interface disconnects from the base station.

35. The device of claim 31, wherein the communication interface further sends a contact preference to the base station.

36. The device of claim 35, wherein the contact preference is a messaging type selected from the group consisting of short messaging service, multimedia messaging service, instant messaging, and e-mail.

37. The device of claim 31, wherein the power conservation initiation signal is generated by a user of the device.

38. The device of claim 31, wherein the processor further generates the power conservation initiation signal in response to the power level of the device being lower than a predetermined threshold.
